(19) United States
(12) Patent Application Publication
(10) Pub. No.: US 2024/0159376 A1
(43) Pub. Date: May 16, 2024

(54) EFFICIENT LIGHT TRANSMISSION THROUGH DARK SURFACES

(71) Applicant: Magna Closures Inc., Newmarket (CA)

(72) Inventors: Miu TRAIAN, Newmarket (CA); Gabriele Wayne SABATINI, Newmarket (CA)

(21) Appl. No.: 18/499,754

(22) Filed: Nov. 1, 2023

Related U.S. Application Data
(60) Provisional application No. 63/425,791, filed on Nov. 16, 2022.
(60) Provisional application No. 63/455,107, filed on Mar. 28, 2023.

(51) Int. Cl. F21S 43/20; F21S 41/125; F21S 41/20; F21S 43/14

(52) U.S. Cl. CPC F21S 43/255; F21S 41/125; F21S 41/285; F21S 43/14

(57) ABSTRACT

A black exterior taillight assembly for a vehicle includes a blue light source configured to generate blue light. The black exterior taillight assembly also includes a blue filter overlying the blue light source and configured pass the blue light therethrough while blocking other colors of light. The black exterior taillight assembly also includes a phosphor layer overlying the blue filter and configured to absorb the blue light and to emit red light. The black exterior taillight assembly also includes a red filter overlying the phosphor layer and configured to pass the red light therethrough while blocking other colors of light.

### CROSS REFERENCE TO RELATED APPLICATIONS

This U.S. utility patent application claims the benefit of U.S. Provisional Patent Application No. 63/425,791 filed Nov. 16, 2022 and titled: “Efficient Light Transmission Through Dark Surfaces”, and U.S. Provisional Patent Application No. 63/455,107 filed Mar. 28, 2023 and titled: “Efficient Light Transmission Through Dark Surfaces”, the contents of which are incorporated herein by reference in their entirety.

### FIELD

The present disclosure relates to exterior lights for a vehicle, such as a taillight, and which has a dark or black appearance when in an OFF state.

### BACKGROUND

This section provides background information related to the present disclosure which is not necessarily prior art.

Automotive manufacturers are always looking for ways to improve the styling of their vehicles. Lights, such as taillights, may be designed to look deep black when in an “off” state and to illuminate when in an on state. For example a “black” appearing taillight may be configured to pass functional light to function as a running light, a turn signal, and a brake light. The conventional way of providing a black taillight is to include a dark tinted lens overlying a red light source producing relatively high intensity red light, so at least some amount of the red light can pass through the dark tinted lens when the red light source is on. Typical light transmission through such dark tinted lenses is between 5% and 8%, making such conventional black taillights very inefficient.

### SUMMARY

This section provides a general summary of the disclosure, and is not a comprehensive disclosure of its full scope or all of its features.

The present disclosure provides a light assembly for a vehicle, comprising: a light source; and one or more optical filters adapted to prevent passage of external light incident on the light assembly to provide the light assembly with a black color appearance and allow light generated from the light source to illuminate the light assembly with a non-black color appearance

The present disclosure also provides a black exterior light assembly for a vehicle. The black exterior light assembly includes a blue light source configured to generate blue light. The black exterior light assembly also includes a blue filter overlying the blue light source and configured pass the blue light therethrough while blocking other colors of light. The black exterior light assembly also includes a phosphor layer overlying the blue filter and configured to absorb the blue light and to emit red light. The black exterior light assembly also includes a red filter overlying the phosphor layer and configured to pass the red light therethrough while blocking other colors of light.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a side view of a vehicle;

FIG. 2A shows a schematic diagram of a conventional black taillight assembly in an OFF state;

FIG. 2B shows a schematic diagram of the conventional black taillight assembly in an ON state;

FIG. 3A shows a black taillight assembly of the present disclosure above a conventional black taillight assembly, and both in the OFF state;

FIG. 3B shows a black taillight assembly of the present disclosure above a conventional black taillight assembly, and both in the ON state;

FIG. 4 shows a schematic diagram of a first high-efficiency black taillight assembly of the present disclosure, in an OFF state;

FIG. 5 shows a schematic diagram of the first high-efficiency black taillight assembly of FIG. 4, in an ON state; and

FIG. 6 shows a schematic diagram of a second high-efficiency black taillight assembly of the present disclosure, in an ON state.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is an objective of the present disclosure to provide a black taillight assembly having improved efficiency. More specifically, it is an objective of the present disclosure to provide a black taillight assembly with efficiency between 2 and 10 times greater than conventional black taillights.

The present disclosure provides a black taillight using a phosphor layer sandwiched between a short-pass filter and a long-pass filter. Shorter wavelength light (for example blue) pass through the short-pass filter and excites the phosphor layer. The phosphor layer converts the shorter length light to a higher wavelength (e.g. red or amber for a taillight). That light then passes through the long-pass filter. When seen from outside the vehicle, the long-pass filter and the short-pass filter block outside light from passing through, effectively making the assembly look black.

The present disclosure provides example embodiments of a black taillight assembly for a vehicle. Such a black taillight assembly may appear black or very dark when in an OFF state, and which illuminates when in an ON state. For example, such a black taillight assembly may emit red and/or amber light, depending on a particular function, such as for a turn signal indicator or a brake light. The principles of the present disclosure may be implemented in other exterior lights for a vehicle, such as in a headlight or in a side marker light.

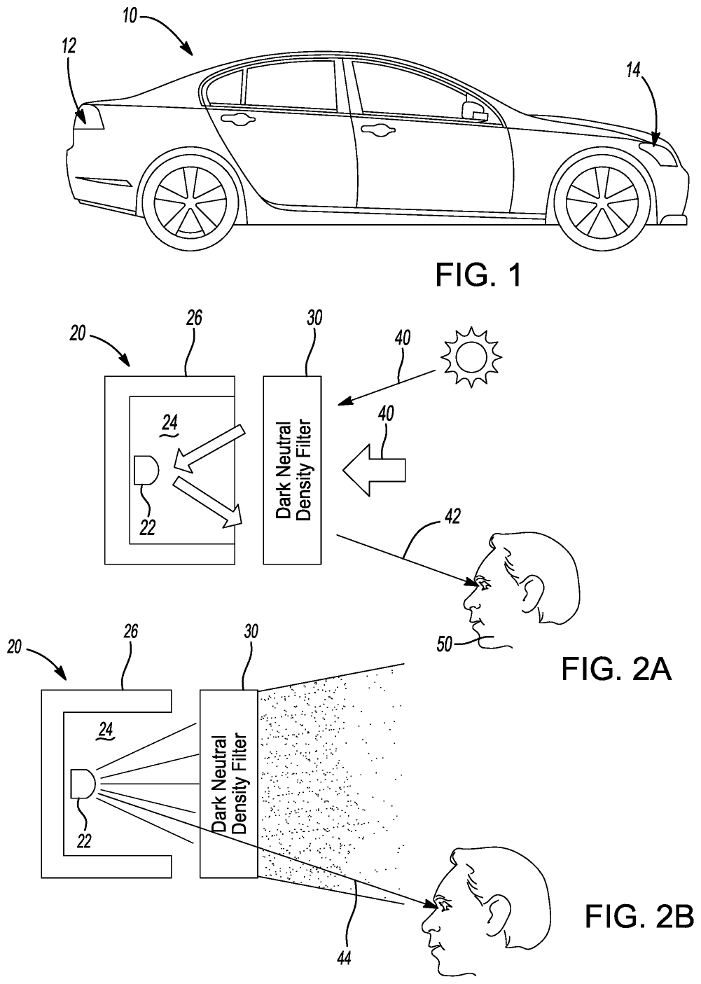

FIG. 1 shows a side view of a vehicle 10 including a taillight assembly 12 and a headlight assembly 14. Either or both of the taillight assembly 12 and a headlight assembly 14 may be configured as a “black” light assembly. When such a black light assembly 12, 14 is in an OFF State, the light assembly 12, 14 appears black, compared to known light assemblies, which show when in the off state a colour, such as red, yellow, or clear. When the black light assemblies 12, 14 are illuminated, also called an ON State, the black light assembly will show a color. e.g. red if a brake light is activated, or yellow if a signal light is activated.

FIG. 2A shows a schematic diagram of a conventional black taillight assembly 20 in an OFF state, and FIG. 2B shows a schematic diagram of the conventional black taillight assembly 20 in an ON state. The conventional black taillight assembly 20 includes a light source 22, such as a plurality of red light emitting diodes (LEDs) disposed within a chamber 24 of a housing 26. A dark neutral density filter 30 overlies the chamber 24 of the housing 26 and reflects some incident light 40, such as sunlight, as reflected light 42 which is substantially attenuated, and which, therefore causes the conventional black taillight assembly 20 to appear to a viewer 50 with a blackened appearance when the light source 22 is OFF. As shown in FIG. 2B, some light can pass through the dark neutral density filter 30 from the light source 22, when the light source 22 is ON, thereby providing a dim illumination 44 to the viewer 50.

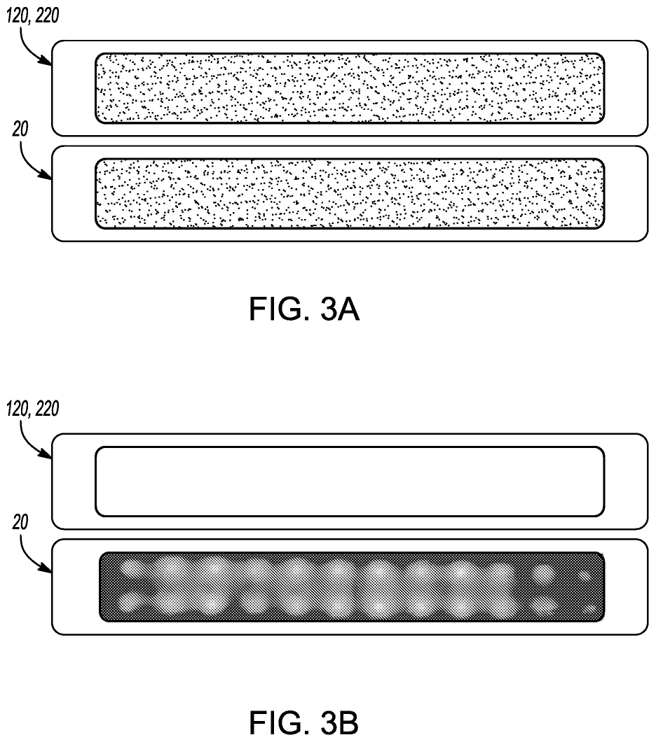

FIG. 3A shows a black taillight assembly of the present disclosure 120, 220 above a conventional black taillight assembly 20, and both in the OFF state. As shown, the black taillight assembly of the present disclosure 120, 220 has a black appearance that is similar or identical to the black appearance of the conventional black taillight assembly 20 in the OFF state. FIG. 3B shows a black taillight assembly of the present disclosure 120, 220 above a conventional black taillight assembly 20, and both in the ON state. As can be seen, the black taillight assembly of the present disclosure 120, 220 has a uniform brightness that is much brighter than the conventional black taillight assembly 20.

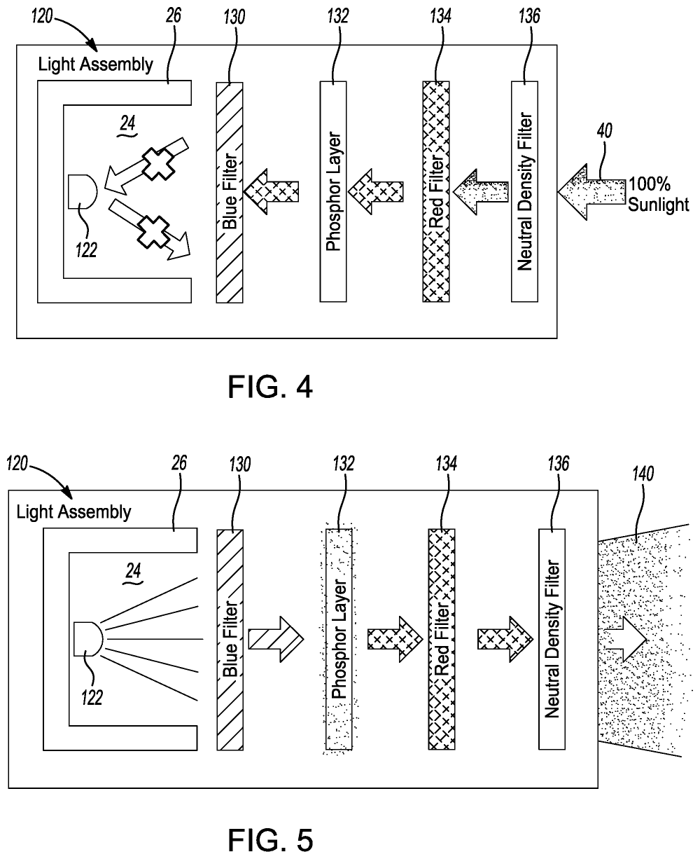

FIG. 4 shows a schematic diagram of a first high-efficiency black taillight assembly 120 of the present disclosure, in an OFF state. The principles of the present disclosure may be applied to other types of vehicle light assemblies, such as marker lights or turn signal indicators. The first high-efficiency black taillight assembly 120 may be called, more generally, a Light Assembly. The first high-efficiency black taillight assembly 120 includes a housing 26 defining a chamber 24, which may be similar or identical to the housing 26 of the conventional black taillight assembly 20. A blue light source 122, such as a blue LED is disposed in the chamber 24 of the first high-efficiency black taillight assembly 120 and configured to emit blue light when in an energized or ON state. However, the first high-efficiency black taillight assembly 120 may include any number of the blue light sources 122. The blue light sources 122 may include standard blue LEDs configured to generate the blue light with a wavelength of about 450 nanometers (nm). However, other types of blue light sources may be used.

A blue filter 130, which may be called a blue-pass filter, overlies the chamber 24 of the housing. The blue filter 130 allows blue light to pass through while blocking other colors of light. A phosphor layer 132 overlies the blue filter 130, so the blue filter 130 extends between the phosphor layer 132 and the blue LED. The phosphor layer 132 is configured to absorb the blue light and to emit red light. In some embodiments, the phosphor layer 132 may include a quantum dot (q-dot) structure configured to convert the frequency of photons incident thereupon to convert the blue light to the red light.

The first high-efficiency black taillight assembly 120 also includes a red filter 134, which may be called a red-pass filter, overlying the phosphor layer 132 so the phosphor layer 132 extends between the blue filter 130 and the red filter 132. The red filter 134 allows red light to pass through while blocking other colors of light. A first neutral density filter 136, which may provide some dimming across a wide range of colors, overlies the red filter 134. The first neutral density filter 136 may have a higher transmissivity to provide substantially less dimming than the dark neutral density filter 30 of the conventional black taillight assembly 20.

Either or both of the blue filter 130 and/or the red filter 134 may be configured as a bandpass filter to selectively pass only a given range of frequencies of light. The red filter 134 and the blue filter 130, together, block transmitted dimmed sunlight. No colour is reflected, providing a darkened or black look to the exterior surface the first high-efficiency black taillight assembly 120.

FIG. 5 shows a schematic diagram of the first high-efficiency black taillight assembly of FIG. 4, in an ON state, with the blue light source 122 illuminated. Blue light from the blue light source 122 passes through the blue filter 130 and is converted to red light by the phosphor layer 132. The red light from the phosphor layer passes through the red filter 134 and then through the first neutral density filter 136, where it is emitted as high-intensity red light 140. The high-intensity red light 140 is dimmed by the first neutral density filter 136, but by a much lesser extent than the dimming of the dark neutral density filter 30. Thus, the high-intensity red light 140 produced by the first high-efficiency black taillight assembly 120 may have a substantially higher intensity or brightness than the dim illumination 44 produced by the conventional black taillight assembly 20.

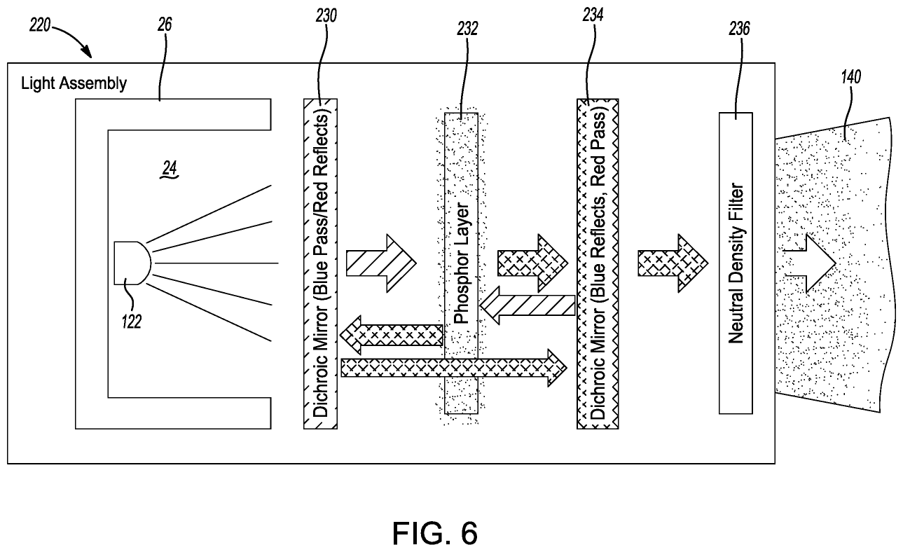

FIG. 6 shows a schematic diagram of a second high-efficiency black taillight assembly 220 of the present disclosure, in an ON state. The principles of the present disclosure may be applied to other types of vehicle light assemblies, such as marker lights or turn signal indicators, and the second high-efficiency black taillight assembly 220 may be called, more generally, a Light Assembly. The second high-efficiency black taillight assembly 220 may be similar or identical to the first high-efficiency black taillight assembly 120, except with a first dichroic mirror 230 in place of the blue filter 130, and with a second dichroic mirror 234 in place of the red filter 134. The second high-efficiency black taillight assembly 220 includes a second phosphor layer 232 that overlies the first dichroic mirror 230, so the first dichroic mirror 230 extends between the second phosphor layer 232 and the blue LED. A second neutral density filter 236, which may provide some dimming across a wide range of colors, overlies the second dichroic mirror 234. The second neutral density filter 236 may have a higher transmissivity to provide substantially less dimming than the dark neutral density filter 30 of the conventional black taillight assembly 20.

The first dichroic mirror 230 may be configured to allow blue light to pass therethrough while reflecting red light. The second dichroic mirror 234 may be configured to allow red light to pass therethrough while reflecting blue light. The second high-efficiency black taillight assembly 220 may function similarly to the first high-efficiency black taillight assembly 120 to produce the high-intensity red light 140 by energizing the blue light source 122 to produce blue light.

The second high-efficiency black taillight assembly 220 may provide increased efficiency by reflecting part of the light from the phosphor layer 132 from the first dichroic mirror 230 back through the phosphor layer 132 and onward through the second dichroic mirror 234.

Either or both of the first high-efficiency black taillight assembly 120 and/or the second high-efficiency black taillight assembly 220 may be configured to produce a homogenous and uniform illumination with a red or amber appearance. For example, the first high-efficiency black taillight assembly 120 and/or the second high-efficiency black taillight assembly 220 may generate a red or other color with a wavelength of greater than 630 nanometers (nm).

The high-efficiency black taillight assemblies 120, 220 of the present disclosure may have a modular design that can be adapted to a variety of different sizes and/or shapes for various different applications. The high-efficiency black taillight assemblies 120, 220 of the present disclosure may support multiple different functions, such as “taillight”, “brake”, and “turn signal” functions, while also providing a darkened or “black” aesthetic look when in an OFF state.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A light assembly for a vehicle comprising:
a light source; and
one or more optical filters adapted to prevent passage of external light incident on the light assembly to provide the light assembly with a black color appearance and allow light generated from the light source to illuminate the light assembly with a non-black color appearance.

2. The light assembly of claim 1, wherein the light source includes a blue light source configured to generate blue light; and
wherein the one or more optical filters include a blue filter overlying the blue light source and configured pass the blue light therethrough while blocking other colors of light.

3. The light assembly of claim 2, wherein the blue light source includes a blue light emitting diode (LED).

4. The light assembly of claim 3, wherein the blue light source includes a plurality of blue light emitting diodes (LEDs).

5. The light assembly of claim 2, wherein the blue filter includes a dichroic mirror.

6. The light assembly of claim 2, further comprising:
a phosphor layer overlying the blue filter and configured to absorb the blue light and to emit red light; and
a red filter overlying the phosphor layer and configured to pass the red light therethrough while blocking other colors of light.

7. The light assembly of claim 6, wherein the red filter includes a dichroic mirror.

8. The light assembly of claim 6, further comprising a neutral density filter overlying the red filter.

9. The light assembly of claim 6, wherein the phosphor layer includes a quantum dot (q-dot) structure configured to convert a frequency of photons incident thereupon to convert the blue light to the red light.

10. The light assembly of claim 1, wherein the light assembly is configured as one of:
a running light, a turn signal, or a brake light.

11. The light assembly of claim 1, wherein the light assembly is configured as a taillight assembly to be mounted on a rear of the vehicle.

12. A black exterior light assembly for a vehicle, comprising:
a blue light source configured to generate blue light;
a blue filter overlying the blue light source and configured pass the blue light therethrough while blocking other colors of light;
a phosphor layer overlying the blue filter and configured to absorb the blue light and to emit red light; and
a red filter overlying the phosphor layer and configured to pass the red light therethrough while blocking other colors of light.

13. The black exterior light assembly of claim 12, further comprising a neutral density filter overlying the red filter.

14. The black exterior light assembly of claim 12, wherein the blue filter includes a dichroic mirror.

15. The black exterior light assembly of claim 12, wherein the red filter includes a dichroic mirror.

16. The black exterior light assembly of claim 12, wherein the phosphor layer includes a quantum dot (q-dot) structure configured to convert a frequency of photons incident thereupon to convert the blue light to the red light.

17. The black exterior light assembly of claim 12, wherein the blue light source includes a blue light emitting diode (LED).

18. The black exterior light assembly of claim 17, wherein the blue light source includes a plurality of blue light emitting diodes (LEDs).

19. The black exterior light assembly of claim 12, wherein the light assembly is configured as one of: a running light, a turn signal, or a brake light.

20. The black exterior light assembly of claim 12, wherein the exterior light assembly is configured as a taillight assembly to be mounted on a rear of the vehicle.
